(19) United States
(12) Patent Application Publication
(10) Pub. No.: US 2014/0240273 A1
(43) Pub. Date: Aug. 28, 2014

(54) APPARATUS AND METHOD FOR INTERACTING WITH A USER

(71) Applicant: SONY CORPORATION, Tokyo (JP)

(72) Inventors: Steven Friedlander, San Diego, CA (US); Louis Luat Le, San Diego, CA (US)

(73) Assignee: SONY CORPORATION, Tokyo (JP)

(21) Appl. No.: 13/778,652

(22) Filed: Feb. 27, 2013

(51) Int. Cl. G06F 3/044

(52) U.S. Cl. CPC G06F 3/044
USPC 345/174

(57) ABSTRACT

An apparatus and method for interacting with a user are provided. The apparatus includes a display device operable to display a user interface where the user interface is overlaid on a two-way reflective mirror. The apparatus further includes at least one capacitive sensor coupled to the two-way reflective mirror where the at least one capacitive sensor is operable to generate one or more proximity signals in response to detection of a touchless interaction of an object with the two-way reflective mirror. Further, the apparatus includes one or more processors communicatively coupled to the at least one capacitive sensor where the one or more processors are operable to determine whether one or more values of the generated one or more proximity signals are greater than one or more predefined threshold values.

### CROSS-REFERENCE TO RELATED APPLICATIONS/INCORPORATION BY REFERENCE

None.

### FIELD

Various embodiments of the disclosure relate to an interactive device. More specifically, various embodiments of the disclosure relate to a method and apparatus for interacting with a user.

### BACKGROUND

Recent developments in interactive digital consumer products have seen a move towards making day-to-day objects more interactive. Users are increasingly using the devices for checking their e-mails, weather information, traffic routes, etc. For example, users can now check personalized information related to weather, schedule for the day, week or current month on their devices. Further, some of the applications on these devices may enable users to read news, traffic information, a day's calendar, among other information on their devices.

However, there are several inactive devices that a user may use during the day. These inactive devices range from mirrors that the users use to see themselves in the morning to glass tables in restaurants, offices, and at home. Given the focus on increasing the interactive nature of inactive devices, there is a need for these inactive devices to become active and provide more information to the user in real time.

Further limitations and disadvantages of conventional and traditional approaches will become apparent to one of skill in the art, through comparison of described systems with some aspects of the present disclosure, as set forth in the remainder of the present application, with reference to the drawings.

### SUMMARY

An apparatus and method for interacting with a user as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating an interactive device, in accordance with an embodiment of the disclosure.

FIG. 2 is a block diagram illustrating system components of an interactive device, in accordance with an embodiment of the disclosure.

FIG. 3 is a user interface illustrating different applications that may run on the interactive device, in accordance with an embodiment of the disclosure.

FIG. 4 is a diagram illustrating a method for interacting with an interactive device, in accordance with an embodiment of the disclosure.

### DETAILED DESCRIPTION

Various implementations may be found in an apparatus and a method for interacting with a user. The method may include navigating within an application via an interactive device. In an embodiment, the interactive device may comprise at least one two-way reflective mirror that is communicatively coupled with a display device. Further, the method may include detecting at least one touchless user gesture on the interactive device, based on capacitive sensing. Moreover, the method may include navigating within the application based on the detected at least one touchless user gesture on the interactive device.

In exemplary embodiments of the method for interacting with the user, the navigating comprises one or more of a zoom-in function, a zoom-out function, a change of view function, and/or movement of the application on the interactive device.

Exemplary embodiments of the method for interacting with the user may include navigating from a first set of applications to a second set of applications through the interactive device in response to the detected at least one touchless user gesture.

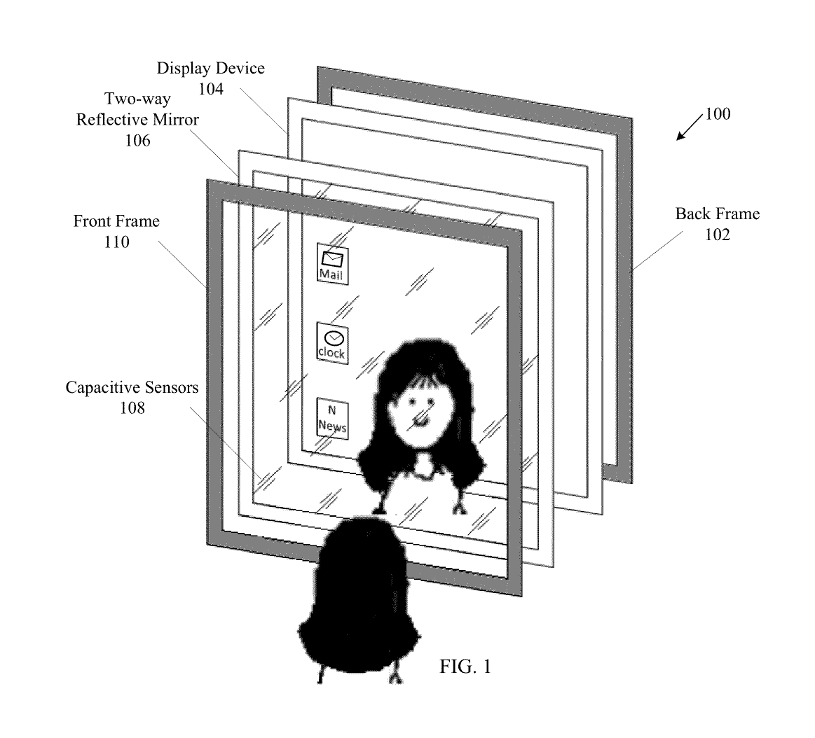

FIG. 1 is a block diagram illustrating an interactive device 100, in accordance with an embodiment of the disclosure. In reference to FIG. 1, there is shown the interactive device 100. The interactive device 100 may comprise a back frame 102, a display device 104, a two-way reflective mirror 106, one or more capacitive sensors 108, and a front frame 110.

The back frame 102 of the interactive device 100 is a frame on which the interactive device 100 rests. The back frame 102 may be made of any material including, but not limited to, iron, stainless steel, wood, and/or hardened plastic. The back frame 102 supports the interactive device 100 and various components of the interactive device 100, such as the display device 104, the two-way reflective mirror 106, the one or more capacitive sensors 108, the front frame 110, and other components.

The display device 104 may be any display device capable of displaying audio-visual content and/or information in a graphical form. The display device 104 may be a computer and/or consumer device or appliance, such as, a network-enabled smart television, a digital media center, a gaming console, an internet-enabled set-top box, and/or other network-enabled media playback devices capable of playing a range of media content formats and displaying the results on a screen. The display device 104 may comprise logic, circuitry, interfaces, and/or code that may be operable to display content on a screen of the display device 104. The display device 104 may comprise one or more processors and at least one graphical user interface unit. The one or more processors may be communicatively coupled with the two-way reflective mirror 106.

The display device 104 may comprise suitable logic, circuitry, interfaces, and/or code that may enable the display device 104 to communicate with a communication network through a wired or a wireless communication protocol. Examples of the communication network may include, but are not limited to, the Internet, a Wireless Fidelity (WiFi) network, a Wireless Local Area Network (WLAN), a Local Area Network (LAN), a telephone line (POTS), and/or a Metropolitan Area Network (MAN). Various devices in a network environment may be operable to connect to the display device 104, in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The two-way reflective mirror 106 is placed in front of the display device 104 such that the contents displayed on the display device 104 may be seen through the two-way reflective mirror 106. In an embodiment, the two-way reflective mirror 106 may be made in such a way that the two-way reflective mirror 106 allows about half of incident light to pass through and reflects the other half of the incident light from both of its sides. In an embodiment, the two-way reflective mirror 106 may be a half-silvered glass surface having a reflecting metal film (such as aluminum). The reflecting metal film is deposited on the glass surface so that approximately 45-50 percent of incident light is reflected. In practice, the two-way reflective mirror 106 looks exactly like a standard, one-way mirror. However, the two-way reflective mirror 106 is equally reflective from both sides, so it is critical that the observation side be much less illuminated (ideally pitch black) than the side that is being observed. The two-way reflective mirror 106 may include one or more capacitive sensors 108 on its surface.

The one or more capacitive sensors 108 may be coupled to a surface of the two-way reflective mirror 106. The one or more capacitive sensors 108 may comprise suitable logic, circuitry, interfaces, and/or code that may be operable to detect presence of an object without any physical contact. In an embodiment, the one or more capacitive sensors 108 may be proximity sensors. The one or more capacitive sensors 108 may enable touchless interaction of an object with the interactive device 100. The one or more capacitive sensors 108 may be operable to detect touchless interaction of an object with the two-way reflective mirror 106. The one or more capacitive sensors 108 may be operable to generate one or more proximity signals in response to detection of the touchless interaction. The one or more capacitive sensors 108 may be communicatively coupled with the display device 104. Further, the one or more capacitive sensors 108 may communicate the generated one or more proximity signals to the display device 104.

In an embodiment, the one or more capacitive sensors 108 on the two-way reflective mirror 106 may be enabled by coating one side of the two-way reflective mirror 108 with a layer of Indium Tin Oxide (ITO). The size of the ITO enabled sensors typically is ½″×1″. However, the capacitive sensing enabled by such smaller sensors may be relatively low. Accordingly, to enable complete touchless interaction between the user and the interactive device 100, mega-sized ITO sensors, typically of the sizes 3″×7″ may be used to implement complete touchless interaction between the user and the interactive device 100. Notwithstanding, the disclosure may not be so limited and any other materials similar in properties to ITO may be used to enable capacitive sensing on the two-way reflective mirror 106 without limiting the scope of the disclosure.

The front frame 110, along with the back frame 102, may hold the entire assembly of the interactive device 100 together. As with the back frame 102, the front frame 110 may be made of any material including, but not limited to, iron, stainless steel, wood, and/or hardened plastic.

In operation, a user of the interactive device 100 may perform touchless interaction with the interactive device 100. For example, the user may provide a gesture input to the two-way reflective mirror 106. In an embodiment, the gesture performed may include one or more of sliding, panning and/or hovering of an object within a predetermined range from the two-way reflective mirror 106.

The one or more capacitive sensors 108 on the two-way reflective mirror 106 may detect the gesture input. The one or more capacitive sensors 108 may generate one or more proximity signals based on the detected gesture input. The one or more capacitive sensors 108 may be communicatively coupled with one or more processors in the display device 104. Further, the one or more capacitive sensors 108 may communicate the proximity signals to the one or more processors in the display device 104. The one or more processors in the display device 104 may compare one or more values of the one or more proximity signals with one or more predefined threshold values stored in a memory of the display device 104. Thereafter, the one or more processors of the display device 104 may activate at least one operation corresponding to the gesture input, if the one or more values of the one or more proximity signals are more than the one or more predefined threshold values. If the one or more values of the one or more proximity signals are more than the one or more predefined threshold values, the one or more processors may display corresponding information on the display device 104, in response to the gesture input provided by the user at the interactive device 100.

In another embodiment, when a user comes near the two-way reflective mirror 106, the one or more capacitive sensors 108 may be activated. The one or more capacitive sensors 108 may detect the presence of the user. The one or more capacitive sensors 108 may communicate the presence of the user to one or more processors in the display device 104. Further, the one or more capacitive sensors 108 may receive user input in form of hand gestures and/or commands. The one or more capacitive sensors 108 may communicate the received hand gestures and/or the commands to the one or more processors in the display device 104. For example, a user may provide input by drawing letter ‘C’ in front of the two-way reflective mirror 106. The one or more capacitive sensors 108 may sense the input and communicate the input to the one or more processors in the display device 104. The one or more processors in the display device 104 may decode the input received from the user. The one or more processors may perform an operation corresponding to the received input. For example, the gesture ‘C’ may correspond to execute a calendar application and display contents of a calendar associated with the user on the display device 104.

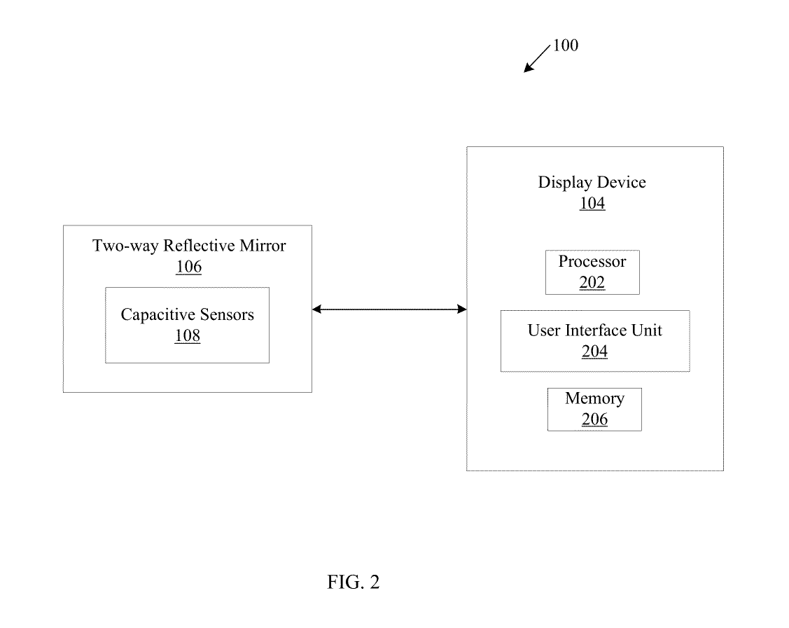

FIG. 2 is a block diagram illustrating system components of the interactive device 100, in accordance with an embodiment of the disclosure. FIG. 2 is described in conjunction with elements from FIG. 1. In reference to FIG. 2 there is shown the two-way reflective mirror 106 and the display device 104 of the interactive device 100. Further, FIG. 2 shows the one or more capacitive sensors 108 in the two-way reflective mirror 106. As explained earlier, the one or more capacitive sensors 108 are enabled on the two-way reflective mirror 106 by coating one side of the two-way reflective mirror 106 with a special material. The one or more capacitive sensors 108 enable proximity sensing on the two-way reflective mirror 106.

In an embodiment, the display device 104 may include a processor 202, a user interface unit 204, and a memory 206. The processor 202 may comprise one or more processors or may be a single processor capable of all the computing needs of the display device. The processor 202 may comprise suitable logic, circuitry, interfaces, and/or code that may be operable to execute a set of instructions stored in the memory 206. The processor 202 may be implemented based on a number of processor technologies known in the art. Examples of the processor 202 may be an X86-based processor, a RISC processor, an ASIC processor, a CISC processor, or any other processor.

The user interface unit 204 of the display device 104 may be operable to display one or more applications and/or information on the display device 104. The user interface unit 204 receives input from the processor 202 and displays the information. Further, the processor 202 may instruct the user interface unit 204 to display information pertaining to specific touchless gestures that the user of the interactive device 100 performs on the interactive device 100. The user interface 204 may be communicatively coupled to the memory 206.

The memory 206 of the display device 104 may be a memory to store instructions and other data related to the operation of the interactive device 100. The memory 206 may comprise suitable logic, circuitry, interfaces, and/or code that may be operable to store the received set of instructions. The memory 206 may be implemented based on, but not limited to, a Random Access Memory (RAM), a Read-Only Memory (ROM), a Hard Disk Drive (HDD), a storage server and/or a secure digital (SD) card.

In operation, the one or more capacitive sensors 108 of the two-way reflective mirror 106 may capture the touchless interaction made by the user of the interactive device 100. For example, if the user focuses on an application of the interactive device 100 and then brings his hand closer to the two-way reflective mirror 106, the one or more capacitive sensors 108 may generate proximity signals based on the distance between the hand of the user and the two-way reflective mirror 106. The one or more proximity signals, thus generated, are sent to the processor 202 of the display device 104. The processor 202 compares the one or more values of the one or more proximity signals with the one or more predefined threshold values. In an embodiment, the one or more predefined threshold values may be stored in the memory 206. If the one or more values of the one or more proximity values are found to be more than the one or more predefined threshold values by the processor 202, the processor executes the instructions. In this specific example, if the one or more values of the one or more proximity signals are found to be more than the one or more predefined threshold values, the application is changed from, say, a month-long view of calendar to a week-long view of the user's calendar. In another embodiment, a calendar application may also be changed from a week-long view to a day-long view or hour-long view, based on the distance between the user's hand and the two-way reflective mirror 106.

Similarly, the one or more capacitive sensors 108 of the two-way reflective mirror 106 may detect the directional gestures made by the user of the interactive device 100. For example, the user may choose one of the applications, say a TV Series application, on the interactive device 100 and may move it to another place on the interactive device 100. The application may be moved with a hand gesture which moves from the original position of the TV Series application to the new position of the TV Series application. The one or more capacitive sensors 108 capture the one or more values of the one or more proximity signals generated by the user's gestures and directions and sends them to the processor 202. The processor 202 compares the one or more values of the one or more proximity signals with the one or more predefined threshold values stored in the memory 208. Based on the comparison, the processor 202 instructs the user interface unit 206 to move the position of the TV Series application from its original position to the new position indicated by the user.

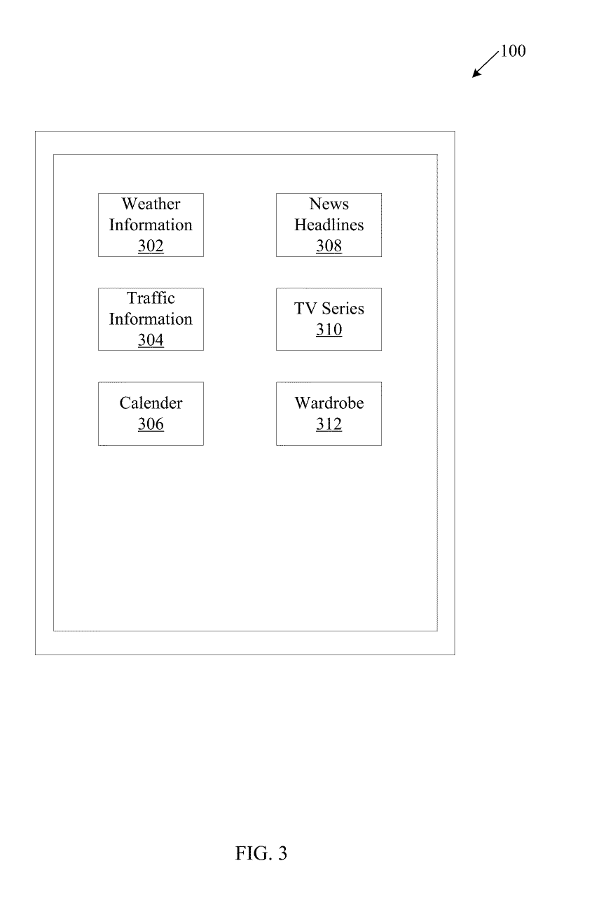

FIG. 3 is a user interface illustrating different applications that may run on the interactive device 100, in accordance with an embodiment of the disclosure. FIG. 3 is described in conjunction with elements from FIG. 1. In reference to FIG. 3, there is shown the interactive device 100 and a sample of different applications that may be displayed on the interactive device 100. The interactive device 100 displays a Weather Information 302, a Traffic Information 304, a Calendar 306, a News Headlines 308, a TV Series 310, and a Wardrobe 312. Notwithstanding, the disclosure may not be so limited and any other types of information may be displayed on the interactive device 100 without limiting the scope of the disclosure.

The Weather Information 302 may display weather information on the display device 104. The display device 104 may be communicatively coupled to a communication network that may source the weather information from a centralized weather information server (not shown in FIG. 3). Customization for the Weather Information 302 may be performed by the user of the interactive device 100. The Weather Information 302 may be customized to show the weather information for the day or the weather prediction for the week or for the whole month. Further, the Weather Information 302 may be customized to display weather information for a predefined number of hours of the day. The Traffic Information 304 may display traffic information on the display device 104. The display device 104 is communicatively coupled to a communication network that may source the traffic information from a centralized traffic server (not shown in FIG. 3). The Traffic Information 304 may be customized to show the traffic information for the route that the user of the interactive device 100 wants to take for the day. Alternatively, the Traffic Information 304 may also display traffic information about a route that the user wants to see information about but does not necessarily want to follow. The source for the traffic information may be a variety of sources such as Google Maps™, Apple Maps™, or maps provided by TomTom™, or Garmin™, or any other such traffic and map service. The user of the interactive device 100 may customize or prioritize where the traffic information should be sourced from.

The Calendar 306 displays a calendar or schedule for the user for the day, week, or month of their choosing. The display device 104 is communicatively coupled to a network calendar associated with the user of the interactive device 100 and sources the calendar information for Calendar 306 from the network calendar. Changes that the user of the interactive device 100 makes on the network calendar are reflected on the Calendar 306 on the interactive device 100. The user of the interactive device 100 may customize the graphical user interface for the Calendar 306. Further, the user of the interactive device 100 may also customize the graphical user interface of the Calendar 306 by providing input to the interactive device 100.

The News Headlines 308 displays the latest news headlines for the user of the interactive device 100. The News Headlines 308 may source the news headlines from a single source or a variety of sources through the display device 104 that is communicatively coupled to a communication network. Examples of the sources of news headlines include, but are not limited to, Google News™, New York TImes™, and/or Reuters™. The user of the interactive device 100 may customize the news headlines that they want to see on the News Headlines 308.

The TV Series 310 displays an audio-video content that the user of the interactive device 100 wants to see. The audio-video content may be sourced from a centralized or a distributed network of audio-video content servers (not shown in FIG. 3) and routed to the TV Series 310 via the display device 104.

The Wardrobe 312 displays the clothes that the user of the interactive device 100 wants to wear and/or see. The user may select from a database of clothes stored in the memory 206 of the display device 104. The clothes may be displayed on the user's image that is either stored in the memory of the display device 104 or is taken in real time through a camera (not shown in FIG. 3) of the interactive device 100. The user of the interactive device 100 may thus decide whether a particular set of clothes are suiting the user on the particular day or in the particular moment. The users can virtually try different clothes for the day and then choose the ones that they want to wear by using the Wardrobe 312.

In an embodiment, a user of the interactive device 100 may navigate through different applications or customize and change the view of applications on the interactive device 100. Further, the user of the interactive device 100 may zoom-in or zoom-out in different applications on the interactive device 100. For example, while viewing the clothes for the day in the Wardrobe 312, the user may change from a first set of clothes to a second set of clothes by panning his hand over the interactive device 100 from left of the interactive device 100 to right of the interactive device. When the user pans his hand from left to right on the interactive device 100, the one or more capacitive sensors 108 on the two-way reflective mirror 106 recognize the gesture made by the user. The one or more capacitive sensors 108 generate proximity signals corresponding to the gesture made by the user and communicate the proximity signals to the one or more processors in the display device 104. The one or more processors in the display device 104 compare the one or more values of the one or more proximity signals with the one or more predefined threshold values and decide if the one or more values of the one or more proximity signals are more than the one or more predefined threshold values. If the one or more values of the one or more proximity signals are more than the one or more predefined threshold values, the one or more processors interpret the gesture as a valid command and effect an operation corresponding to the command. For example, in this example, the one or more processors recognize that the user wants to change the clothes that are currently displayed on the interactive device 100, and accordingly pulls out a different set of clothes from the memory of the display device 104 and shows them on the clothes information 312 of the interactive device 100. Similarly, by using specific hand gestures from left to right on the interactive device 100, the user may also navigate through different applications on the interactive device 100.

In an embodiment, when the user moves his hand closer to the interactive device 100, the one or more capacitive sensors 108 detect the decreasing distance between the user's hand and the interactive device 100. The one or more processors in the display device 104 detect the decreasing distance and accordingly zoom-in on a view of the application running on the interactive device. The user can also perform a zoom-out function on an application of the interactive device 100 by moving his hand away from the interactive device.

The user of the interactive device 100 may perform other similar operations by using the one or more capacitive sensors 108 on the two-way reflective mirror 106. The one or more processors of the display device 104 may customize the information displayed on the interactive device 100 in response to the gesture input provided by the user.

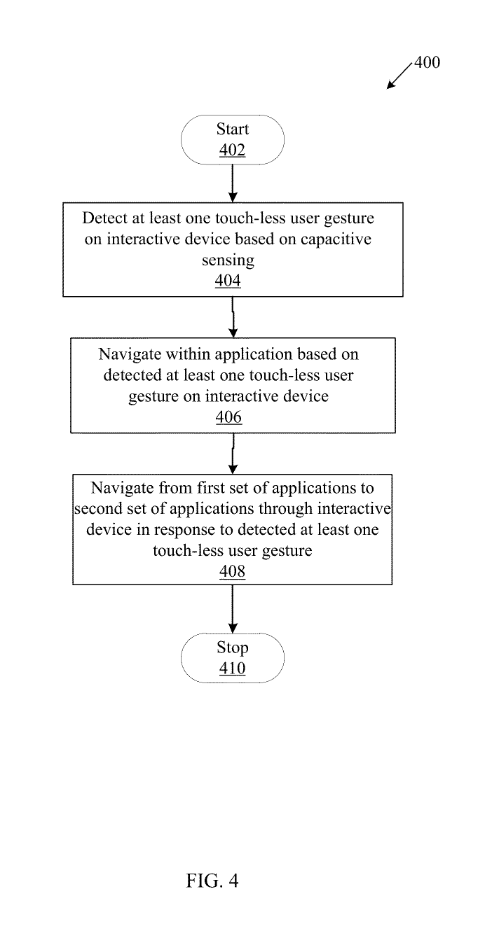

FIG. 4 is a flow chart illustrating exemplary steps for navigating within an application through an interactive device 100, in accordance with an embodiment of the disclosure. In reference to FIG. 4, there is shown a method 400. The method 400 is described in conjunction with the elements described in FIG. 1, FIG. 2, and FIG. 3.

The method begins at step 402. In an embodiment, the method includes the one or more capacitive sensors 108 of the two-way reflective mirror 106. The one or more capacitive sensors 108 detect the at least one touchless user gesture on the interactive device 100, based on capacitive sensing at step 404. At step 406, the method includes navigating within the application based on the detected at least one touchless user gesture on the interactive device 100. According to an exemplary embodiment, at step 408, the interactive device 100 allows navigation from a first set of applications to a second set of applications through the interactive device 100, in response to the detected at least one touchless user gesture.

In an exemplary embodiment, an apparatus for interacting with a user is provided. The apparatus includes a display device operable to display a user interface. The user interface may be overlaid on a two-way reflective mirror. Further, the apparatus includes at least one capacitive sensor coupled to the two-way reflective mirror 106. The at least one capacitive sensor being operable to generate one or more proximity signals in response to detection of a touchless interaction of an object with the two-way reflective mirror 106. Finally, the apparatus includes one or more processors communicatively coupled to the at least one capacitive sensor. The one or more processors being operable to determine whether the one or more values of the generated one or more proximity signals are greater than the one or more predefined threshold values.

Further, in an embodiment, the one or more processors in the apparatus are operable to convert each of the generated one or more proximity signals into a corresponding set of coordinates in a coordinate system.

In an embodiment, the one or more processors in the apparatus are operable to generate a difference signal based on a difference between a first proximity signal and a second proximity signal of the generated one or more proximity signals. The one or more processors are also operable to determine an operation of the object based on the generated difference signal. The one or more threshold values determine one or more parameters of the operation. Moreover, the one or more processors are operable to determine a location of the object with respect to the two-way reflective mirror, where the location is determined based on the first proximity signal component and a second proximity signal component.

In another embodiment, the apparatus operation comprises one or more of navigation within an application and/or navigation across a plurality of applications. The operation may further comprise one or more gestures performed by the object and the gestures may include one or more of sliding, panning and/or hovering of the object within a predetermined range from the two-way reflective mirror 106.

According to various embodiments, an interactive device 100 for navigating within an application is provided. The interactive device 100 may comprise at least one two-way reflective mirror 106 which is communicatively coupled with the display device 104. Further, the interactive device 100 may include at least one capacitive sensor 108 that is operable to detect at least one touchless user gesture on the interactive device 100. The interactive device 100 may also include one or more processors operable to navigate within the application, based on the detected at least one touchless user gesture on the interactive device 100.

In an embodiment, the one or more processors of the interactive device 100 are operable to navigate from a first set of applications to a second set of applications through the interactive device 100, in response to the detected at least one touchless user gesture.

Other embodiments of the disclosure may provide a non-transitory computer readable medium, and/or storage medium, and/or a non-transitory machine-readable medium and/or storage medium. Having applicable mediums stored thereon, a machine code and/or a computer program having at least one code section executable by a machine and/or a computer, may thereby cause the machine and/or computer to perform the steps of navigating within an application through an interactive device 100. The interactive device 100 comprises at least one two-way reflective mirror 106 communicatively coupled with a display device 104. At least one touchless user gesture is detected on the interactive device 100, based on capacitive sensing. Further, navigation is made possible within the application, based on the detected at least one touchless user gesture on the interactive device 100.

Accordingly, the present disclosure may be realized in hardware, or a combination of hardware and software. The present disclosure may be realized in a centralized fashion, in at least one computer system, or in a distributed fashion, where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. An apparatus for interacting with a user, the apparatus comprising:
a display device operable to display a user interface, wherein said user interface is overlaid on a two-way reflective mirror;
at least one capacitive sensor coupled to said two-way reflective mirror, wherein said at least one capacitive sensor is operable to generate one or more proximity signals in response to detection of a touchless interaction of an object with said two-way reflective mirror; and
one or more processors communicatively coupled to said at least one capacitive sensor, wherein said one or more processors are operable to determine whether one or more values of said generated one or more proximity signals are greater than one or more predefined threshold values.

2. The apparatus of claim 1, wherein said one or more processors are operable to convert each of said generated one or more proximity signals into a corresponding set of coordinates in a coordinate system.

3. The apparatus of claim 1, wherein said one or more processors are operable to:
generate a difference signal based on a difference between a first proximity signal and a second proximity signal of said generated one or more proximity signals; and
determine an operation of said object based on said generated difference signal.

4. The apparatus of claim 3, wherein said operation comprises navigation within an application.

5. The apparatus of claim 3, wherein said operation comprises navigation across a plurality of applications.

6. The apparatus of claim 3, wherein said operation comprises one or more gestures performed by said object.

7. The apparatus of claim 6, wherein said one or more gestures comprise one or more of: sliding, panning and/or hovering of said object within a predetermined range from said two-way reflective mirror.

8. The apparatus of claim 1, wherein said one or more predefined threshold values determine one or more parameters of said operation.

9. The apparatus of claim 1, wherein said one or more predefined threshold values are stored in a memory.

10. The apparatus of claim 1, wherein said one or more processors are operable to determine a location of said object with respect to said two-way reflective mirror, wherein said location is determined based on said first proximity signal component and a second proximity signal component.

11. An interactive device for navigating within an application, said interactive device comprising at least one two-way reflective mirror communicatively coupled with a display device, said interactive device comprising:
at least one capacitive sensor operable to detect at least one touchless user gesture on said interactive device; and
one or more processors operable to navigate within said application based on said detected at least one touchless user gesture on said interactive device.

12. The interactive device of claim 11, wherein said at least one capacitive sensor is operable to generate one or more proximity signals in response to detection of said at least one touchless user gesture on said interactive device.

13. The interactive device of claim 12, wherein said at least one capacitive sensor is operable to communicate said generated one or more proximity signals to said display device.

14. The interactive device of claim 11, wherein said one or more processors are operable to navigate from a first set of applications to a second set of applications through said interactive device in response to said detected at least one touchless user gesture.

15. A method of navigating within an application via an interactive device, said interactive device comprising at least one two-way reflective mirror communicatively coupled with a display device, said method comprising:
detecting at least one touchless user gesture on said interactive device based on capacitive sensing; and
navigating within said application based on said detected at least one touchless user gesture on said interactive device.

16. The method of claim 15, wherein said navigating comprises one or more of:
zoom-in function, zoom-out function, change of view function, and/or movement of said application on the interactive device.

17. The method of claim 15, further comprising navigating from a first set of applications to a second set of applications through said interactive device in response to said detected at least one touchless user gesture.

18. A non-transitory computer-readable storage medium having stored thereon, a computer program having at least one code section executable by a computer for causing the computer to perform steps comprising:
in an interactive device comprising at least one two-way reflective mirror communicatively coupled with a display device:
detecting at least one touchless user gesture on said interactive device based on capacitive sensing; and
navigating within an application through said interactive device based on said detected at least one touchless user gesture on said interactive device.

19. The non-transitory computer-readable storage medium of claim 18, wherein said navigation is performed between a plurality of applications through said interactive device in response to said detected at least one touchless user gesture.

20. The non-transitory computer-readable storage medium of claim 18, wherein said two-way reflective mirror is coupled to at least one capacitive sensor, wherein said at least one capacitive sensor generates one or more proximity signals in response to said detected at least one touchless user gesture, wherein one or more values of said generated one or more proximity signals are compared with one or more predefined threshold values.
